(19) United States
(12) Patent Application Publication
(10) Pub. No.: US 2026/0080504 A1
(43) Pub. Date: Mar. 19, 2026

(54) ADAPTIVE GRID PARTITIONING FOR MULTICAMERA BIRD'S EYE VIEW FUSION

(71) Applicant: QUALCOMM Incorporated, San Diego, CA (US)

(72) Inventors: Varun Ravi Kumar, San Diego, CA (US); Kiran Bangalore Ravi, Paris (FR); Senthil Kumar Yogamani, San Diego, CA (US)

(21) Appl. No.: 18/886,101

(22) Filed: Sep. 16, 2024

(51) Int. Cl. G06T 3/4038; G06V 10/764; G06V 20/56

(52) U.S. Cl. CPC G06T 3/4038; G06V 10/764; G06V 20/56

(57) ABSTRACT

A method for generating an adaptive Birds-Eye-View (BEV) grid includes obtaining sensor data generated by one or more sensors of a vehicle, wherein the sensor data includes one or more images captured by one or more cameras of a first type having a first detection range and one or more images captured by one or more cameras of a second type having a second detection range; extracting, from the sensor data, a plurality of features to generate a plurality of multi-scale image features; projecting the plurality of multi-scale image features onto a BEV space representing an environment surrounding the vehicle; generating an adaptive BEV grid comprising a plurality of grid cells that incorporates a combination of the plurality of multi-scale image features; and adjusting a size of one or more of the plurality of grid cells based on one or more pre-defined factors.

### TECHNICAL FIELD

This disclosure relates to image processing.

### BACKGROUND

Among other challenges, autonomous driving systems need to accurately detect and track moving objects such as vehicles, pedestrians, and cyclists in real time. In autonomous driving, accurately estimating the state of surrounding obstacles is critical for safe and robust path planning. However, this perception task is difficult, particularly for generic obstacles, due to appearance and occlusion changes. Perceptual errors can manifest as braking and swerving maneuvers that can be unsafe and uncomfortable. Many contemporary autonomous driving systems utilize a “detect then track” approach to perceive the state of objects in the environment. This approach has strongly benefited from recent advancements in 3-D object detection and state estimation. However, this approach often suffers errors as it relies on geometric consistency of the object detection results over time.

### SUMMARY

Traditional Bird's Eye View (BEV) grids use a uniform size for all areas. Fisheye cameras have a wider field of view (FOV) than regular cameras, leading to significant overlap between their images in the BEV grid. This overlap creates redundancy and requires handling distortion for accurate object representation. This disclosure describes techniques for using a non-uniform BEV grid where the grid size may adapt based on the camera capturing that area. In other words, areas covered by fisheye cameras with high resolution and short detection range may get finer grids for precise detail. Regions captured by long-range cameras with lower resolution may get coarser grids. The disclosed techniques may provide more accurate representation of object information from various cameras. These techniques may further provide efficient use of computational resources by focusing processing power on areas that need it (e.g., fisheye coverage). The disclosed techniques may maintain detection precision by using appropriate grid resolution for data of each camera.

In other words, the disclosed techniques include the use of a flexible grid system that allocates more detail to areas with high-resolution fisheye camera coverage and may simplify areas with less detail from long-range cameras. These techniques may optimize processing power while maintaining accuracy and leveraging the redundancy of overlapping fisheye data for a robust understanding of the surroundings.

In one example, a method for generating an adaptive Birds-Eye-View (BEV) grid includes obtaining sensor data generated by one or more sensors of a vehicle, wherein the sensor data includes one or more images captured by one or more cameras of a first type having a first detection range and one or more images captured by one or more cameras of a second type having a second detection range; extracting, from the sensor data, a plurality of features to generate a plurality of multi-scale image features; projecting the plurality of multi-scale image features onto a BEV space representing an environment surrounding the vehicle; generating an adaptive BEV grid comprising a plurality of grid cells that incorporates a combination of the plurality of multi-scale image features; and adjusting a size of one or more of the plurality of grid cells based on one or more pre-defined factors.

In another example, a system for generating an adaptive Birds-Eye-View (BEV) grid includes a memory for storing sensor data; and processing circuitry in communication with the memory. The processing circuitry is configured to obtain the sensor data generated by one or more sensors of a vehicle. The sensor data includes one or more images captured by one or more cameras of a first type having a first detection range and one or more images captured by one or more cameras of a second type having a second detection range. The processing circuitry is also configured to extract, from the sensor data, a plurality of features to generate a plurality of multi-scale image features and project the plurality of multi-scale image features onto a BEV space representing an environment surrounding the vehicle. The processing circuitry is further configured to generate an adaptive BEV grid comprising a plurality of grid cells that incorporates a combination of the plurality of multi-scale image features. A size of one or more of the plurality of grid cells is adjusted based on one or more pre-defined factors.

In yet another example, non-transitory computer-readable storage media having instructions encoded thereon, the instructions configured to cause processing circuitry to: obtain sensor data generated by one or more sensors of a vehicle. The sensor data includes one or more images captured by one or more cameras of a first type having a first detection range and one or more images captured by one or more cameras of a second type having a second detection range. Additionally, the instructions are configured to cause processing circuitry to: extract, from the sensor data, a plurality of features to generate a plurality of multi-scale image features and project the plurality of multi-scale image features onto a BEV space representing an environment surrounding the vehicle. Furthermore, the instructions are configured to generate an adaptive BEV grid comprising a plurality of grid cells that incorporates a combination of the plurality of multi-scale image features. A size of one or more of the plurality of grid cells is adjusted based on one or more pre-defined factors.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example autonomous vehicle, in accordance with the techniques of this disclosure.

FIG. 2 is a block diagram illustrating an example system that may perform the techniques of this disclosure.

FIG. 3 illustrates Lift Splat Shoot concept applied to images provided by fisheye and long-range cameras, in accordance with the techniques of this disclosure.

FIG. 4 illustrates adaptive BEV grid generation based on the information provided by two types of cameras.

FIG. 5 is a block diagram illustrating implementation of the perception system configured to generate an adaptive BEV grid, in accordance with the techniques of this disclosure.

FIG. 6 is a flowchart illustrating an example method for generating an adaptive BEV grid, in accordance with the techniques of this disclosure.

### DETAILED DESCRIPTION

Autonomous driving systems and/or advanced driving assistance systems (ADAS) rely on various sensors like cameras, LiDAR, radar, etc., each with its strengths and weaknesses. Cameras may provide rich visual information but may struggle in low light or challenging weather. LiDAR may offer accurate distance measurements but may have limited range or be sensitive to rain. Radar may excel at detecting objects in all weather conditions but may lack detailed visual information. A sensor data fusion approach combines sensor data before any high-level processing like object detection or classification takes place. The goal of the sensor data fusion is to create a more comprehensive and robust understanding of the environment by leveraging the combined strengths of different sensors.

A common representation used in sensor data fusion is the BEV space. BEV stands for Bird's Eye View. The BEV space is a representation of the 3D world from a top-down perspective, similar to looking down at a map. In the context of autonomous driving and computer vision, BEV space is an important concept for understanding and processing sensor data. Fisheye cameras have a wider view but may only see objects close by (shorter detection range). A long-range camera may see much farther but may have a narrower view. This mismatch may mean that objects from fisheye cameras may only occupy a small area of the BEV grid. Furthermore, the aforementioned mismatch may mean that objects from the long-range camera may span a much larger area. A single grid resolution may not be suitable for both situations. Due to the fisheye lens and shorter range, objects may appear smaller on the BEV grid despite being close. Conversely, objects from the long-range camera may appear larger because they are closer and captured at higher resolution. This difference in object size and detail may make it difficult to use a single grid resolution that works well for both types of cameras.

Fisheye cameras may capture a wide view but may distort objects, while the long-range camera may have a narrower view but may capture objects more accurately. Fisheye cameras may see objects close by, while the long-range camera may see farther.

The aforementioned differences may cause spatial misalignment and difficulty integrating information. Objects may appear in different grid cells depending on the camera that detected them. It may be challenging to combine data from all cameras into a cohesive picture due to these misalignments.

To overcome the aforementioned challenges, the present disclosure describes techniques for using non-uniform grids in the BEV space. The grid size may be adjusted based on the camera capturing that area. Areas with high-resolution, short-range fisheye coverage may get finer grids to capture details. Regions captured by the long-range camera with lower resolution may get coarser grids. In other words, different grid resolutions may better represent objects based on the camera that detected them (smaller for fisheye, larger for long-range).

As an additional benefit of non-uniform grids, processing power may be focused on areas needing more detail (fisheye coverage). Using appropriate grid resolution for each camera, as described in greater detail below, may better ensure more accurate object detection.

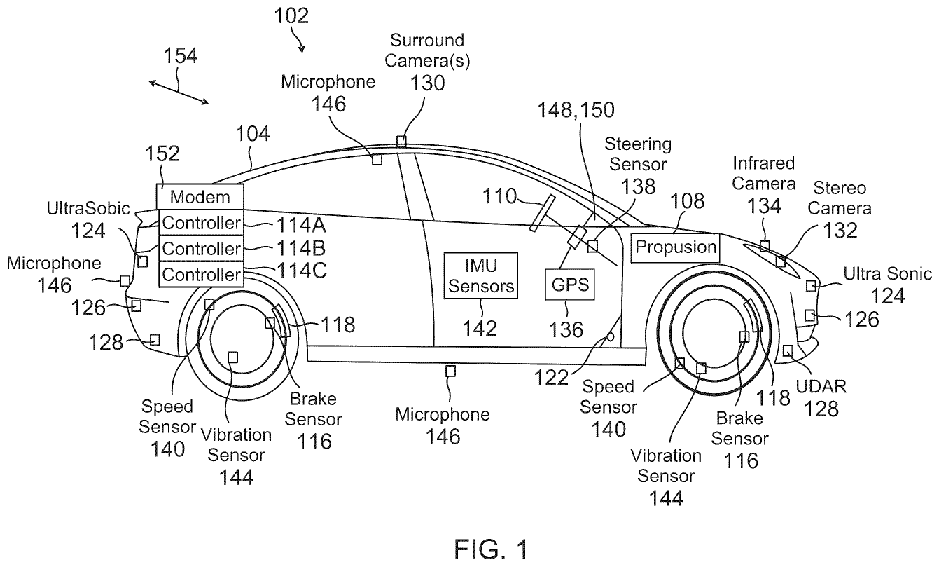

FIG. 1 shows an example vehicle 102. Vehicle 102 in the example shown may comprise a passenger vehicle such as a car or truck that can accommodate a human driver and/or human passengers. In an aspect, vehicle 102 may comprise an autonomous vehicle, semi-autonomous vehicle and/or vehicle with an ADAS system. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be essentially one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be obtained with dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, Global Positioning System (“GPS”) data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more RADAR sensors 126, one or more LiDAR sensors 128, one or more surround cameras 130 (typically such cameras are located at various places on vehicle body 104 to image areas all around the vehicle body), one or more stereo cameras 132 (in an aspect, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller has identified the presence of a stop sign, caution sign, or changing traffic light and is taking appropriate action, giving the vehicle occupants peace of mind that the controller 114 is functioning as intended.

In an aspect, instrument cluster 148 may include a separate controller/processor configured to perform deep learning and artificial intelligence functionality.

Vehicle 102 may collect data that is preferably used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

Compared to sonar and RADAR sensors 126, cameras 130-134 may generate a richer set of features at a fraction of the cost. Thus, vehicle 102 may include a plurality of cameras 130-134, capturing images around the entire periphery of the vehicle 102. At least some of the surround cameras 130 may be fisheye cameras. Fisheye cameras are a type of wide-angle lens that may be used in vehicles to provide a broader view of the surroundings than a traditional rearview mirror or camera. Fisheye cameras typically have a viewing angle of around 170 degrees or even up to 180 degrees, which can be very helpful for tasks such as, but not limited to: parking, backing up, blind spot monitoring, etc. Camera type and lens selection depends on the nature and type of function. The vehicle 102 may have a mix of camera types and lenses to provide complete coverage around the vehicle 102; in general, narrow lenses do not have a wide field of view but can see farther. All camera locations on the vehicle 102 may support interfaces such as Gigabit Multimedia Serial link (GMSL) and Gigabit Ethernet.

In an aspect, a controller 114 may start by gathering data generated by one or more sensors 126-134 of the vehicle 102. For example, sensors may include cameras 130-134, LiDAR sensors 128, RADAR sensors 126, or a combination of these. The sensor data may include one or more images captured by one or more cameras having a long detection range and one or more images captured by one or more cameras having a short detection range (e.g., fisheye cameras). Next, controller 114 may extract, from the sensor data, a plurality of features to generate a plurality of multi-scale image features. These multi-scale image features may capture details at various resolutions for richer information. Controller 114 may then project the plurality of multi-scale image features onto a BEV space representing an environment surrounding the vehicle. The BEV space may capture the overall scene information from all cameras. Finally, controller 114 may generate an adaptive BEV grid comprising a plurality of grid cells that incorporates a combination of the plurality of multi-scale image features. A size of one or more of the plurality of grid cells may be adjusted based on one or more pre-defined factors. Adaptive grid partitioning techniques described in greater detail below may enable capturing details of objects at varying distances from the vehicle, resulting in a more accurate BEV representation.

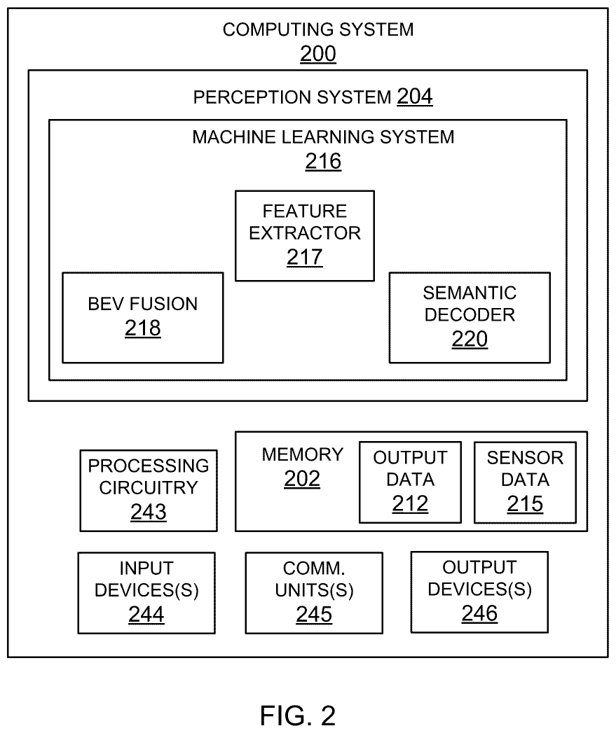

FIG. 2 is a block diagram illustrating an example computing system 200. As shown, computing system 200 comprises processing circuitry 243 and memory 202 for executing Machine Learning (ML) system 216 of perception system 204, including feature extractor 217, BEV fusion unit 218, and semantic decoder 220 which may represent an example instance of any controller 114 described in this disclosure, such as controller 114 of FIG. 1. Perception system 204 may be a component of an autonomous driving system, such as ADAS. ML system 216 may comprise various types of neural networks, such as, but not limited to, recursive neural networks (RNNs), convolutional neural networks (CNNs), and deep neural networks (DNNs). For example, ML system 216 may also include an object detection model not shown in FIG. 2.

Computing system 200 may also be implemented as any suitable external computing system accessible by controller 114, such as one or more server computers, workstations, laptops, mainframes, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules or units described in accordance with one or more aspects of this disclosure.

Processing circuitry 243 and memory 202 may provide an operating environment or platform for one or more modules or units (e.g., feature extractor 217, BEV fusion unit 218, and semantic decoder 220), which may be implemented as software, but may in some examples include any combination of hardware, firmware, and software. Processing circuitry 243 may execute instructions and the one or more storage devices, e.g., memory 202, may store instructions and/or data of one or more modules or units. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute perception system 204 using virtualization modules, such as a virtual machine or container executing on underlying hardware. One or more of such modules may execute as one or more services of an operating system or computing platform. Aspects of perception system 204 may execute as one or more executable programs at an application layer of a computing platform.

One or more input devices 244 of computing system 200 may generate, receive, or process input. Such input may include input from a video camera, sensor, keyboard, pointing device, voice responsive system, biometric detection/response system, button, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

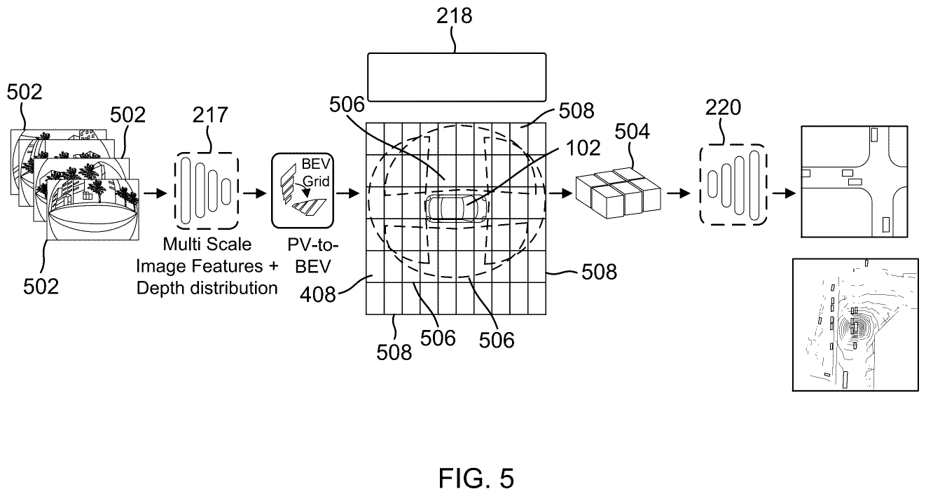

In the example of FIG. 2, feature extractor 217 may be configured to extract features from sensor data 215, as described herein. Feature extractor 217 may receive input from sensors such as, but not limited to, cameras 130-134 (including fisheye and long range cameras), LiDAR sensor(s) 128, RADAR sensors 126, and/or ultrasonic sensors 124. Semantic decoder 220 may generate output data 212. Output data generated by feature extractor 217 (e.g., multi scale image features, depth distribution, etc.) may be used as input data for BEV fusion unit 218 of the perception system 204 (as shown in FIG. 5). Sensor data 215 and output data 212 may contain various types of information. For example, sensor data 215 may include, but is not limited to, camera image data, LiDAR point cloud data, and so on. Output data 212 may include adaptive two dimensional BEV grid, BEV space feature map, and so on.

In an aspect, feature extractor 217 may comprise a CNN. In an aspect, the feature extractor 217 may receive a plurality of fisheye camera images. The feature extraction process may result in “multi-scale image features,” capturing details at various resolutions for richer information. In an aspect, the CNN used for feature extraction may be trained to predict the depth distribution for each pixel in the fisheye image. The BEV fusion unit 218 may be configured to perform multi-camera BEV fusion. The sensor data (e.g., camera image or LiDAR point cloud) may be represented as an adaptive BEV grid by the BEV fusion unit 218, where each pixel or point represents a specific location in the sensor's view. In an aspect, the BEV fusion may involve merging the information from BEV features of each camera onto the corresponding cells in the adaptive grid. Adaptive grid partitioning techniques described in greater detail below may enable capturing details of objects at varying distances from the vehicle, resulting in a more accurate BEV representation. An example semantic decoder 220 may predict the class labels (e.g., lane, car, pedestrian) for each cell in the grid, providing a semantic understanding of the environment. Alternatively, the semantic decoder 220 may predict the type, location, and size (3D bounding box) of objects present in the scene directly from the BEV representation. Advantageously, adaptive grid partitioning techniques may allocate higher resolution only to areas requiring it (near the vehicle), leading to more efficient use of computational resources. The output generated by the semantic decoder 220 may comprise the final BEV space feature map.

Using the received BEV space feature data, an autonomous driving system (the control system of the vehicle 102) may generate a real-time map of surroundings of vehicle 102 and may identify potential obstacles or traffic signals. The generated adaptive BEV grid and space feature data may become the primary source of information for the autonomous driving system (e.g., ADAS system). The autonomous driving system may analyze the adaptive BEV grid to understand the surrounding environment in detail, particularly focusing on details of objects at varying distances. Based on this detailed understanding, the autonomous driving system may make decisions about appropriate actions. Such decisions may include, but are not limited to: warning the driver of potential hazards (e.g., pedestrians crossing the street); providing steering or braking assistance to maintain lane position or avoid collisions; adapting cruise control speed based on surrounding traffic.

In an aspect, the disclosed techniques may capture detailed information close to the sensors while maintaining a good level of coverage throughout the BEV space.

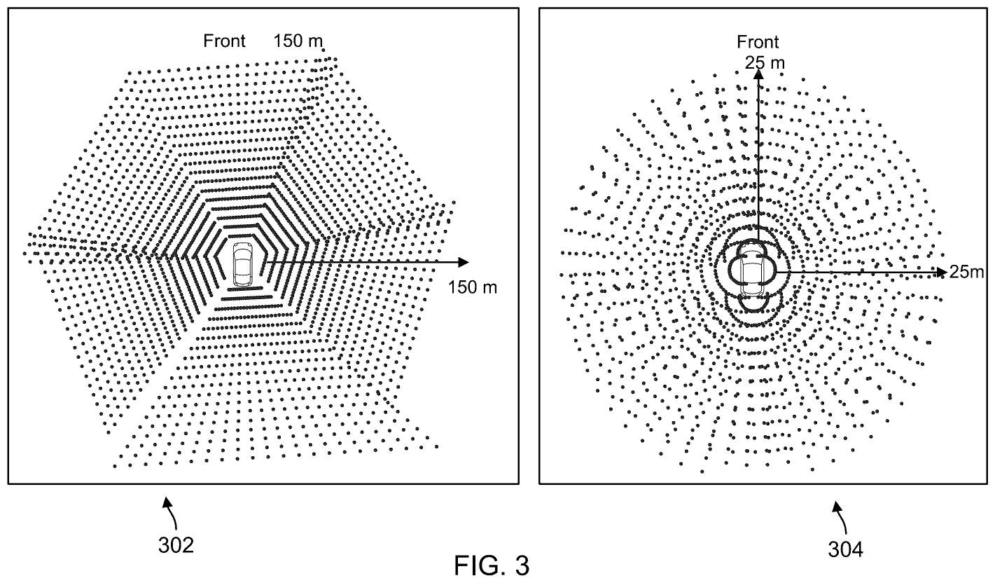

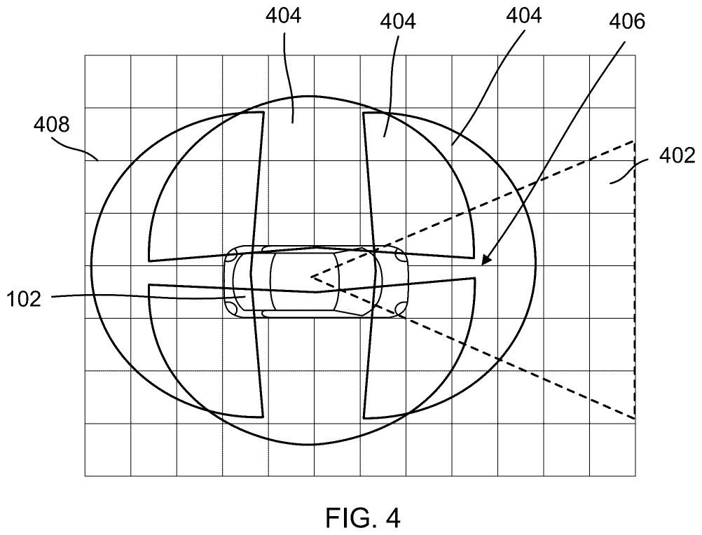

FIG. 3 illustrates Lift Splat Shoot concept applied to images provided by fisheye and long-range cameras to produce a BEV image, in accordance with the techniques of this disclosure. Lift, Splat, Shoot (LSS) is a concept that may be applied in the field of computer vision, particularly for autonomous vehicles. At lift stage individual images from each camera (fisheye or long-range) may be processed by a CNN, such as feature extractor 217. The lift stage may extract features like shapes, edges, and potential objects within the image. The extracted features from image of each camera may then be “projected” onto a virtual 3D space, often represented as a bird's-eye view (BEV) of the surroundings (splat stage). The aforementioned splat stage is similar to splattering paint onto a canvas. The corresponding 3D spaces (virtual 3D space 302 generated based on the images provided by long range cameras and virtual 3D space 304 generated based on the images provide by fisheye cameras) may capture the overall scene information from all cameras. The BEV representation(s) may then be used for various tasks at shooting stage. In the context of autonomous vehicles, “shooting” may involve, but is not limited to: segmentation and motion planning. Segmentation may include classifying different elements in the BEV like lanes, drivable areas, and obstacles. ADAS may use the BEV information, such as BEV grid 408 shown in FIGS. 4 and 5, for example, to plan safe trajectories for the vehicle 102 to navigate the environment. Wide field of view of fisheye cameras may allow the perception system 204 of ADAS to capture a larger portion of the surroundings in the “lift” stage. Fisheye camera images may provide a more comprehensive picture for tasks like obstacle detection in blind spots. Long range cameras may capture details further away. In the “lift” stage, the feature extractor 217 may extract features from distant objects, allowing the BEV to have a better understanding of the overall layout of the environment.

FIG. 4 illustrates adaptive BEV grid generation based on the information provided by two types of cameras. It should be noted that the overlap area 406 between the front long-range camera (e.g., 150 m range 402) and the surround view fisheye cameras (e.g., 50 m range 404) may play an important role in enhancing the BEV representation for autonomous vehicles using the LSS technique.

In an aspect, the redundant information from overlapping areas 406 may provide multiple perspectives of the same scene element.

As explained earlier, during the “Lift” stage of LSS, the feature extractor 217 may leverage these multiple views to improve feature detection and reduce the chances of missing important details. For instance, in the example illustrated in FIG. 3, a partially occluded object in the fisheye view may be fully visible from the perspective of the front camera. In other words, by combining information from both, the perception system 204 of ADAS may create a more accurate representation of the object in the BEV.

The redundancy may act as a safety net. If one camera view is compromised due to factors like sensor noise, glare, or temporary blockage, information from the overlapping fisheye camera may fill the gaps. The redundancy may ensure the BEV represents a consistent and robust depiction of the environment. The overlapping areas 406 may provide complementary details about the same scene element. For example, the fisheye camera may capture the size and shape of an object well, while the front camera may offer a clearer view of its color and texture. By combining this information, the perception system 204 may create a richer feature description in the BEV, leading to more accurate decision-making by ADAS for tasks like obstacle classification and path planning.

In an aspect, there are challenges associated with using data generated by a fisheye camera in a BEV grid for autonomous vehicles.

Fisheye lenses inherently distort straight lines, making objects appear further away or closer than they actually are depending on their position in the image. This distortion may need to be corrected before features are projected onto the BEV grid. As discussed earlier, due to the wide field of view, objects closer to the fisheye camera may appear larger in the image compared to those objects further away. Varying object sizes may create inconsistencies in the BEV grid 408 if a uniform size is used for all features. Slight variations in the mounting positions of multiple fisheye cameras may cause misalignment between their corresponding views in the BEV grid 408.

The aforementioned challenges may lead to inaccurate object positions and gaps in coverage. Unlike a long-range camera with a consistent range 402, the effective detection range 404 of a fisheye camera may vary depending on the object's location in the image. Objects near the edge of the fisheye view may be blurry or difficult to detect due to the distortion. However, instead of a uniform grid, the BEV representation may use an adaptive BEV grid 408 where the cell size varies depending on the distance from the camera, as described below in conjunction with FIG. 5. Adaptive grid resolution may ensure that objects closer to the fisheye camera have a higher resolution in the BEV for better detail capture.

FIG. 5 is a block diagram illustrating implementation of the perception system configured to generate an adaptive BEV grid, in accordance with the techniques of this disclosure. The process illustrated in FIG. 5 may start with capturing images from multiple cameras, including fisheye cameras, surrounding the vehicle 102. These cameras may provide a wide field of view, capturing a significant portion of the environment simultaneously. Each fisheye image 502 may be fed into feature extractor 217 often referred to as an “image backbone” in this context. The feature extractor 217 may analyze the images 502 at different scales to identify patterns, edges, shapes, and potential objects within the scene. This process may result in multi-scale image features, capturing details at various resolutions for richer information. There are two typical approaches to depth estimation: dedicated depth sensor and depth prediction from images. As noted above, some ADAS systems may utilize a separate LiDAR sensor to directly measure depth information for each scene element. Alternatively, the CNN used for feature extraction may be trained to predict the depth distribution for each pixel in the fisheye image 502. This technique may leverage the image content itself to estimate depth.

Overall, regardless of the technique used, the output of the feature extractor 217 may include a depth distribution that represents the probability of an object existing at a specific distance from the camera. Next stage may involve transforming the extracted information from the fisheye camera images into a BEV representation, which is essentially a top-down view of the surroundings. The multi-scale image features and the depth distribution may be combined by perception system 204 to create a “point-voxel” representation. This point-voxel representation may divide the 3D space into small voxels (3D cubes). Each voxel may contain the corresponding image features and depth information for that specific location in the environment. In the illustrated example, the point-voxel (PV) representation may then be projected by BEV fusion unit 218 onto the pre-defined BEV grid 408. The BEV fusion unit 218 may discretize the environment into a BEV grid 408, similar to a chessboard viewed from above.

The BEV fusion unit 218 may utilize techniques like inverse perspective mapping to project the features and depth information from each voxel onto the corresponding cell in the BEV grid 408. Multiple fisheye cameras may provide a more comprehensive view of the surroundings compared to a single camera system. In simpler terms, the overlapping views between cameras may offer redundant information, enhancing the robustness of the BEV representation. Combining multi-scale features with depth information by BEV fusion unit 218 may create a richer description of the environment for tasks like object detection and path planning.

As noted above, each fisheye camera may capture an image 502 and its features may be extracted using the feature extractor 217. The output of BEV fusion unit 218 may include camera BEV features 504, which may represent the combined scene information from each camera's perspective in a BEV format. It should be noted that a common approach may be to create a uniform BEV grid, where the environment is divided into squares of equal size. However, this approach may have limitations. Objects closer to the fisheye camera may appear larger in the image, requiring more resolution in the BEV to capture details. Objects further away may be smaller and may not require the same level of resolution in the BEV.

To address the aforementioned limitations, the BEV fusion unit 218 may employ adaptive grid partitioning. Instead of a uniform grid, the environment may be divided into cells of varying sizes. Cells 506 closer to the virtual camera position (representing the vehicle's location) may be smaller, allowing for higher resolution and better capture of details from nearby fisheye cameras. Cells 508 further away from the vehicle 102 may be larger, accommodating the smaller size of distant objects in the fisheye views. In this case, the BEV fusion unit 218 may perform multi-camera BEV fusion.

In an aspect, the BEV fusion may involve merging the information from features of each camera onto the corresponding cells in the adaptive BEV grid 408. In an aspect, a decoder like another CNN may be applied to the fused BEV representation (BEV features 504 on the adaptive BEV grid 408.

FIG. 5 illustrates such a decoder, more specifically semantic decoder 220, in accordance with the techniques of this disclosure.

An example semantic decoder 220 may predict the class labels (e.g., lane, car, pedestrian) for each cell in the BEV grid 408, providing a semantic understanding of the environment. Alternatively, semantic decoder 220 may predict the type, location, and size (3D bounding box) of objects present in the scene directly from the BEV representation 504. Advantageously, by employing adaptive grid partitioning techniques the BEV fusion unit 218 may allocate higher resolution only to areas requiring it (near the vehicle 102), leading to more efficient use of computational resources. Adaptive grid partitioning may enable capturing details of objects at varying distances from the vehicle 102, resulting in a more accurate BEV representation.

Accordingly, BEV fusion unit 218 may employ adaptive grid partitioning based on the density of object points in the BEV space. In an aspect, adaptive grid partitioning may address a challenge in creating a BEV representation for autonomous vehicles using camera data. A typical approach creates a BEV with a uniform grid, dividing the environment into equally sized cells. However, this typical approach has at least a few limitations. Objects closer to the cameras may appear larger in the image, requiring higher resolution in the BEV for details. Objects further away may be smaller and may not need the same resolution.

The BEV fusion unit 218 may estimate the density of object points (e.g., detected cars, pedestrians) around each cell in the BEV grid 408. In an aspect, BEV fusion unit 218 may use a Gaussian kernel to estimate the density of object points around each grid cell using the following equation (1):

$${D}_{i} ( x , y ) = {Σ}_{j = 1}^{{N}_{i}} \frac{1}{2 𝔫 {σ}_{i}^{2}} {e}^{- \frac{{( x - {x}_{j} )}^{2} + {( y - {y}_{j} )}^{2}}{2 {σ}_{i}^{2}}} \qquad ( 1 )$$

where Dᵢ(x, y) may represent the density estimate for camera i at grid cell (x,y), (x,y), (xⱼ,yⱼ) may represent the coordinates of object points detected by camera i, Nᵢ may represent the total number of object points detected by camera i, σᵢ may represent the bandwidth parameter for camera i, which may control the influence of each object point on the density calculation. A larger σᵢ may consider objects further away from the cell (broader influence), while a smaller σᵢ may focus on closer objects (narrower influence). The BEV fusion unit 218 may adjust the size of the corresponding grid cell based on the estimated density Dᵢ(x, y). With the disclosed techniques, cells in areas with high object density (many detected objects) may become smaller, allowing for higher resolution and better capture of details. Cells in areas with low object density (fewer detected objects) may become larger, accommodating the smaller size of distant objects. Adaptive grid partitioning may allocate higher resolution only to areas requiring it (dense object areas), leading to a more efficient use of computational resources. Adaptive grid partitioning may enable capturing details of objects at varying distances, resulting in a more accurate BEV representation. The following equation (2) defines how the size of each grid cell may be adjusted by the BEV fusion unit 218 based on the density estimate Dᵢ(x, y) calculated in the previous step for a specific camera (i) at a specific location (x, y) in the BEV grid 408:

$${S}_{i} ( x , y ) = {S}_{min} + ( {S}_{max} - {S}_{min} ) \cdot \frac{1}{1 + α \cdot {D}_{i} ( x , y )} \qquad ( 2 )$$

Sᵢ(x, y) may represent the final size of the grid cell for camera i at location (x, y) in the BEV grid 408. Sₘᵢₙ and Sₘₐₓ may define the minimum and maximum allowable sizes for a grid cell.

In an aspect, Sₘᵢₙ may ensure there is enough resolution even in low-density areas. In an aspect, Sₘₐₓ may prevent cells from becoming too small and computationally expensive in high-density areas.

In an aspect, α may be a scaling factor that controls the rate of adaptation.

A smaller α may lead to a more gradual change in cell size based on the density.

In an aspect, even small variations in density may result in smaller adjustments to the cell size.

A larger α may lead to a more aggressive change in cell size based on the density. Significant differences in density may result in larger adjustments to the cell size. Dᵢ(x, y) is the density estimate that may be calculated by equation (1) for camera i at location (x, y) in the BEV grid 408.

As noted above a higher density value may indicate more objects are present in that area. The term

$$\frac{1}{1 + α \cdot {D}_{i} ( x , y )}$$

may act like a scaling factor based on the density estimate. In areas with high density (high Dᵢ(x, y)), the aforementioned factor may approach a value close to 0. This, in turn, may pull the cell size Sᵢ(x, y) closer to the Sₘᵢₙ value, resulting in a smaller cell size for higher resolution. In areas with low density (low Dᵢ(x, y)), the factor may approach a value close to 1. This may pull the cell size (Sᵢ(x, y)) closer to the Sₘₐₓ value, resulting in a larger cell size.

In an aspect, the final cell size Sᵢ(x, y) may be determined by adding this density-based scaling factor to the minimum cell size (Sₘᵢₙ).

In an aspect, each camera may have its own grid overlaid on the scene it captures. These grids may have different cell sizes depending on factors like the camera's resolution and field of view. Here, Sᵢ(x, y) may represent the size of the grid cell at position (x, y) in the i-th camera's grid. In an aspect, the goal of the disclosed techniques is to create a single BEV grid 408 that incorporates information from all cameras. The disclosed techniques achieve this goal by taking the maximum grid size for each cell across all cameras, using the following equation (3):

$${S}_{c o m m o n} ( x , y ) = max \{ {S}_{1} ( x , y ) , {S}_{2} ( x , y ) , … , {S}_{n} ( x , y ) \} \qquad ( 3 )$$

The BEV fusion unit 218 may use the equation (3) to calculate the size of the cell (x, y) in the common BEV grid 408, S_{common}(x, y). The equation (3) calculates the size by finding the maximum value among the corresponding grid cell sizes (Sᵢ(x, y)) from all individual camera grids (i=1 to n). This technique prioritizes capturing the highest resolution details present in any camera's view for that specific grid cell. As a non-limiting example scenario, one camera may have a very zoomed-in view of a specific area, resulting in a smaller, more detailed grid cell. By taking the maximum, the common BEV grid 408 may retain this high-resolution information.

Instead of pre-defined grid sizes for each camera, the disclosed technique may adjust grid sizes based on the density of object points detected by a camera. Areas with a higher concentration of object points may have smaller grid cells to capture the details of those objects more accurately. Conversely, areas with fewer object points may have larger grid cells.

Despite adjusting individual camera grids dynamically, the objective of the BEV fusion unit 218 is to generate a unified BEV grid 408. The BEV fusion unit 218 may achieve this by applying a transformation to each adjusted grid of each camera to align it with the common BEV grid 408. This technique may ensure all information is correctly positioned within the final representation. For example, by using smaller grid cells in areas with dense objects, the BEV fusion unit 218 may improve the ability to detect and represent them accurately in the BEV. Larger grid cells in areas with sparse objects may reduce computational complexity and memory usage without sacrificing significant information. The disclosed techniques may adapt to the specific scene captured by the cameras, making it effective for scenarios with varying object distributions and camera configurations.

Alternatively, the disclosed BEV fusion unit 218 may employ hierarchical grid structure. The BEV fusion unit 218 may divide the BEV space into a layered structure with multiple levels (L).

In an aspect, each level may represent a different scale of detail. Here, the grid size, S_{i,l}(d) may be defined for camera i at a specific level l. This size may depend on the distance (d) from the camera. The grid size S_{i,l}(d) may be defined using formula (4):

$${S}_{i , l} ( d ) = {s}_{i , min , l} + ( {S}_{i , max , l} - {s}_{i , min , l} ) \cdot \frac{{D}_{i} - d}{{D}_{i} - {D}_{min , l}} \qquad ( 4 )$$

S_{i,l}(d) may represent grid size for camera i at distance d (within level l), S_{i,min,l} may represent minimum grid size allowed for camera i at level l. S_{i,max,l} may represent maximum grid size allowed for camera i at level l. These parameters may define the range of possible grid sizes for camera i within this level. Dᵢ may represent detection range of camera i. The detection range may define the maximum distance the camera can reliably detect objects. D_{min,l} may represent minimum depth considered for level l. This may set the boundary between the level and potentially empty space beyond. The equation (4) may essentially interpolate between the minimum and maximum grid size for camera i at level l based on the distance d.
The following is the explanation how equation (4) works.

The term (Dᵢ−d) may represent the distance from the camera to the point of interest (d). The term (Dᵢ−D_{min,l}) may represent the total usable range of the camera within this level (l). The division may provide a weighting factor between 0 (furthest distance) and 1 (closest distance). Multiplying this factor by the difference between S_{i,max,l} and S_{i,min,l} may determine the adjustment from the minimum size. Adding this adjustment to S_{i,min,l} may give the final grid size Sᵢ(d) for camera i at distance d within level l. In other words, the disclosed techniques may allow the BEV fusion unit 218 to perform dynamic grid size adjustments within a level based on distance from the camera. Cameras with longer detection ranges may have a wider range of possible grid sizes compared to those with shorter ranges. The minimum depth for a level may ensure the BEV grid 408 does not extend into potentially empty space beyond the considered range.

After the BEV fusion unit 218 defines camera-specific grid sizes at different levels, the BEV fusion unit 218 may combine the different grids into a single BEV representation. Similar to the previous techniques with fixed grid sizes, this technique may utilize the maximum grid size across all cameras for each cell in the BEV grid, using the following equation (5):

$${S}_{c o m m o n} ( d ) = max \{ {S}_{1 , l} ( d ) , {S}_{2 , l} ( d ) , … , {S}_{N , l} ( d ) \} \qquad ( 5 )$$

The equation (5) may calculate the size of the cell at distance d in the common BEV grid 408, S_{common}(d).

In one non-limiting example, the BEV fusion unit 218 may utilize the equation (5) to calculate the size by finding the maximum value among the corresponding grid sizes, S_{1,l}(d), for all cameras (i=1 to N) at all levels (l). By using the maximum size across levels, areas closer to a camera with a smaller minimum grid size may have finer resolution in the common BEV grid 408. Finer grids may allow for capturing details of nearby objects more accurately. Conversely, for areas further away, the maximum size may come from a camera with a larger minimum grid size, resulting in a coarser grid in the BEV. In an aspect, coarser grids may reduce computational complexity for representing distant, potentially less detailed regions. As noted above, this hierarchical technique may strike a balance between computational efficiency and perceptual coverage. Larger grid cells in distant areas may require less processing power. Finer grids near cameras may provide better detail for nearby objects.

In yet another implementation, the BEV fusion unit 218 may employ hybrid grid designs. The previous explanation focused on hierarchical grids, which may be well-suited for cameras with different detection ranges. The hybrid grid designs techniques may explore uneven grid partitioning for situations with varying object densities within the scene. Traditional BEV grids typically have uniform square cells. In simpler terms, uneven grid partitioning breaks away from this uniformity. In areas with a high density of object points (detected by a camera), the grid cells may become smaller. This adaptation may allow for more precise representation of the objects in those areas. Conversely, in areas with fewer object points, the grid cells may be larger. This adaptation may reduce computational workload without sacrificing significant information in sparse regions. Sᵤₙₑᵥₑₙ(x, y) may represent the size of the grid cell at position (x, y) in the uneven grid for camera i. This technique may combine uneven grid partitioning with existing grid-based methods for both fisheye and long-range cameras. Fisheye cameras may have a wide field of view but often suffer from distortion towards the edges. In an aspect, uneven grids may help manage this distortion by having denser grids closer to the center and coarser grids near the edges.

In an aspect, long-range cameras may benefit from uneven grids by having finer resolutions in areas where objects are expected (e.g., near roadways) and coarser grids in distant, empty areas.

Not all areas within a scene may have varying object densities. In uniform areas with a consistent distribution of objects, a conventional fixed-size grid may be used efficiently. The fixed-size grid may offer a simpler and computationally less expensive approach for representing the uniform regions. S_{fixed}(x, y) may represent the size of the grid cell at position (x, y) in the fixed grid for camera i. The core idea of a hybrid grid design lies in combining the benefits of both uneven and fixed-size grids. To achieve such combination the system may define a hybrid grid size, S_{hybrid}(x, y), for each cell in camera i's grid. The hybrid size may be calculated using a weighted average of the uneven grid size, Sᵤₙₑᵥₑₙ(x, y), and the fixed grid size, S_{fixed}(x, y). In an aspect, the weighting factor, w(x, y) may play an important role in determining the balance between the two techniques.

In an aspect, the weight factor, w(x, y), may be calculated based on the density of object points at the specific grid cell (x, y). Higher object point density may suggest a need for a finer grid, so w(x, y) may be closer to 1. This emphasizes the Sᵤₙₑᵥₑₙ(x, y) in the weighted average, resulting in a smaller hybrid grid size for better detail. Conversely, lower object point density may indicate a suitable area for a fixed-size grid. In this case, w(x, y) may be closer to 0, giving more weight to S_{fixed}(x, y) in the average, leading to a larger hybrid grid size. Functions such as, but not limited to, sigmoid or softmax may calculate the weight factor based on density. These functions may take a real number as input (density in this case) and may output a value between 0 and 1. Sigmoid functions may produce an S-shaped curve, while softmax functions may provide a smoother distribution of weights across multiple categories (uneven vs. fixed grid in this case). Using functions such as sigmoid and softmax may ensure a smooth transition between uneven and fixed-size grids based on the density values.

Uneven grid partitioning may provide finer resolution in areas with dense objects, improving detection accuracy. Fixed size grids may offer computational efficiency in uniform areas. The hybrid design may merge these techniques using a weighted average. The weight may be based on object point density, favoring uneven grids in dense regions and fixed grids in sparse regions. The adaptive BEV grid 408 may dynamically adjust to scene complexity. The BEV fusion unit 218 may focus resources on areas with more information (higher density).

Cameras with varying detection ranges and resolutions may create inconsistencies in a common BEV grid. High-resolution grids for short-range cameras may be computationally expensive for the entire scene. Low-resolution grids for long-range cameras may miss details in areas captured by short-range cameras. The disclosed techniques contemplate using non-uniform grids. In one implementation, the grid cell sizes may vary depending on factors like distance from the camera and desired resolution. In an aspect, the BEV fusion unit 218 may calculate grid sizes using the following equation (6):

$$S ( d ) = r \cdot \frac{{D}_{max} - d}{{D}_{max} - {D}_{min}} \qquad ( 6 )$$

where d may represent a distance from the camera position, r may represent a desired resolution of the BEV grid 408 (smaller value means higher resolution), Dₘₐₓ may represent a maximum detection range among all cameras (assumed to be the long-range camera here, 150 meters), Dₘᵢₙ may represent a minimum detection range among all cameras (assumed to be the fisheye camera here, 50 meters).

The BEV fusion unit 218 may calculate a weighting factor based on the distance from the camera (Dₘₐₓ−d) relative to the total usable range (Dₘₐₓ−Dₘᵢₙ). This factor may then be multiplied by the desired resolution (r). The result, S(d), may represent the grid size for a specific distance d from the camera. Overall, the disclosed techniques may provide higher resolution for areas close to the camera (smaller d), capturing details from high-resolution cameras effectively. Furthermore, the disclosed techniques may provide lower resolution for areas further away (larger d), reducing computational cost for representing distant, potentially less detailed regions captured by long-range cameras.

In an aspect, the system may leverage the S(d) function from equation (6) to calculate the grid sizes for each camera. However, instead of using a single distance d for the entire scene, the system may consider the specific detection range of each camera type. The disclosed system may use D_{fisheye} (50 meters in this example) as the d value in the S(d) function. This may result in grid sizes appropriate for the fisheye camera's shorter range and potentially higher resolution. The system may use D_{long_range} (150 meters in this example) as the d value in the S(d) function. This may calculate grid sizes suitable for the longer range of the long-range camera, potentially with a lower resolution for efficiency in distant areas. However, once the system generates the camera-specific grid sizes, the system may need to combine them into a single BEV grid representation.

In an aspect, the BEV fusion unit 218 may employ an overlay technique. The overlay technique may be similar to placing the individual camera grids on top of a single, empty BEV grid. For each cell in the common BEV grid 408, the BEV fusion unit 218 may compare the grid sizes from all cameras that cover that cell. The final grid size for that cell in the common BEV grid 408, S_{common}, may be determined by the maximum size among all cameras. The following equation (7) may capture this concept:

$${S}_{c o m m o n} = max ( {S}_{fisheye} , {S}_{long - range} ) \qquad ( 7 )$$

Optionally, the maximum size for the common BEV grid 408 may ensure that the common BRE grid 408 retains the highest resolution available from any camera for a specific area, even if other cameras may have lower resolutions in that region. By using the maximum size, the BEV fusion unit 218 may preserve details from high-resolution cameras in areas where they are relevant. The disclosed techniques may adjust the grid size based on the camera that can effectively see that specific area, leading to a more efficient representation for distant regions captured by the long-range camera.

In an aspect, using the maximum size from any camera for each cell in the common BEV grid 408 may guarantee that the cell may hold information about objects detected by any camera that covers that area. While the BEV grid 408 size may adapt based on camera capabilities, the disclosed techniques strive to maintain a consistent resolution across the entire detection area within the limitations set by the maximum size. This consistency may simplify processing and analysis of the BEV grid 408. By combining camera-specific grids with a focus on maximum size, the disclosed techniques may effectively address the challenges mentioned earlier.

In yet another aspect, cameras with shorter ranges may have a higher impact on the grid size in areas they cover, ensuring details are captured. For distant areas, the long-range camera's influence will prevail, promoting efficiency. The maximum size selection may ensure the common BEV grid 408 retains the highest resolution available for a specific area, regardless of the camera that detected the object.

Defining grid sizes based on camera ranges or object densities may be effective but may not always capture the nuances of a scene. Complex scenes with varying object sizes, distributions, and background clutter may benefit from a more adaptive technique. In an aspect, the BEV fusion unit 218 may employ a CNN model (not shown in FIG. 5). Generally, a CNN model may learn complex relationships between input features and desired outputs. In one implementation, a CNN model may be trained to predict the optimal grid size for a specific cell in the BEV grid 408. The size and location of objects within a field of view of camera are important factors. Smaller objects may require finer grid sizes for accurate representation. Objects further away may be suited for larger grid cells to maintain computational efficiency. Areas with high clutter or multiple overlapping objects may benefit from smaller grid sizes to capture details. Depending on the specific application, other features like camera type, sensor data, or lighting conditions may be included.

As noted above, the CNN model may learn to adjust grid sizes based on the specific characteristics of each scene element. Training on a diverse dataset of scenes may allow the CNN model to capture complex relationships between features and optimal grid sizes. The CNN model may potentially handle various scenarios without the need for manually defined rules for every situation.

In an aspect, the input to the aforementioned CNN model may also include distances from camera to objects. For instance, this information may help the CNN model understand the scale of objects within the scene.

In other words, objects closer to the camera may require finer grid sizes for accurate representation compared to distant objects. By incorporating this data, the CNN model may predict size adjustments that prioritize detail in areas with nearby objects. In addition, the input to the CNN model may include scene complexity metrics. Scene complexity metrics may quantify the overall complexity of the scene, which may significantly impact optimal grid sizes. Examples of scene complexity metrics may include but are not limited to: number of objects, occlusions, and the like. Higher object counts may suggest a more cluttered scene, potentially requiring smaller grid sizes to capture details of individual objects. Areas with overlapping objects may benefit from finer grids to disentangle occluded information. In essence, by incorporating complexity metrics, the CNN model may learn to predict adjustments that account for the overall level of detail needed in different regions of the BEV.

In an aspect, including these additional features alongside object sizes and positions may empower the CNN model to make more informed predictions about optimal grid sizes. The CNN model may predict different grid sizes for various regions of the BEV space, resulting in a more adaptive and efficient representation.

In an aspect, finer grids may be prioritized in areas with high object density, scene complexity, or nearby objects, ensuring important details are captured. Larger grid sizes may be predicted for areas with fewer objects or simpler scenes, reducing computational workload without sacrificing significant information. By providing a more comprehensive picture of the scene, the CNN model may potentially make more accurate predictions about optimal grid sizes. Training on data with diverse complexity metrics may allow the CNN model to learn and adapt to a wider range of scenarios.

Fixed rules or CNN-based techniques may not always capture the full complexity of the scene, especially for dynamic environments.

Manually defining reward functions for a CNN model may be challenging. As yet another alternative technique, the BEV fusion unit 218 may use Reinforcement Learning (RL) for grid size optimization. In RL, an agent learns through trial and error by interacting with its environment. In this case, the agent may be responsible for adjusting the grid sizes in the BEV space. In an aspect, the environment may be the BEV space itself, containing information about object distributions, distances, and potentially the results of object detection using different grid sizes.

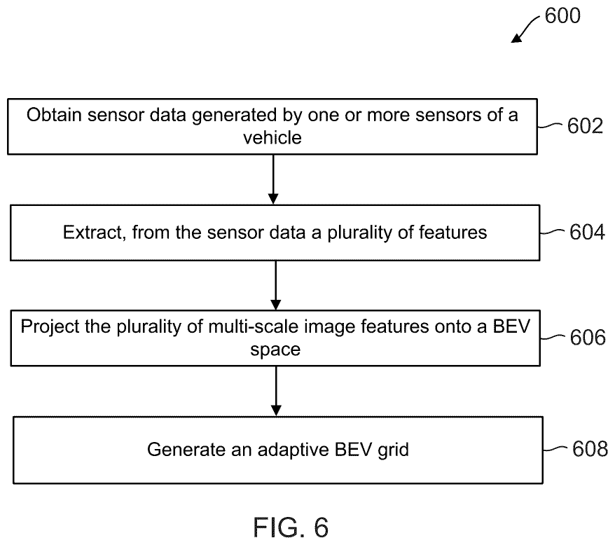

FIG. 6 is a flowchart illustrating an example method for generating an adaptive BEV grid, in accordance with the techniques of this disclosure. Although described with respect to computing system 200 (FIG. 2), it should be understood that other devices may be configured to perform a method similar to that of FIG. 6.

In this example, perception system 204 may initially obtain sensor data from one or more sensor of vehicle 102 (602). The sensor data may include one or more images captured by one or more cameras of a first type having a first detection range and one or more images captured by one or more cameras of a second type having a second detection range (e.g., images captured by a long detection range cameras and images captured by fisheye cameras having a shorter detection range. The perception system 204 may extract, from the sensor data, a plurality of features to generate a plurality of multi-scale image features (604). In one non-limiting example, the perception system 204 (e.g., feature extractor 217) may extract features like, but not limited to, shapes, edges, and potential objects within the image(s). Next, the perception system 204 may project the plurality of multi-scale image features onto a BEV space representing an environment surrounding the vehicle (606). In an aspect, the BEV space may capture the overall scene information from all cameras 130-134. The perception system 204 may generate an adaptive BEV grid comprising a plurality of grid cells that incorporates a combination of the plurality of multi-scale image features (608). A size of one or more of the plurality of grid cells is adjusted based on one or more pre-defined factors. Advantageously, by employing adaptive grid partitioning techniques the perception system 204 may allocate higher resolution only to areas requiring it (near the vehicle 102), leading to more efficient use of computational resources. Adaptive grid partitioning may enable capturing details of objects at varying distances from the vehicle 102, resulting in a more accurate BEV representation.

The following numbered clauses illustrate one or more aspects of the devices and techniques described in this disclosure.

Clause 1. A method for generating an adaptive Birds-Eye-View (BEV) grid includes obtaining sensor data generated by one or more sensors of a vehicle, wherein the sensor data includes one or more images captured by one or more cameras of a first type having a first detection range and one or more images captured by one or more cameras of a second type having a second detection range; extracting, from the sensor data, a plurality of features to generate a plurality of multi-scale image features; projecting the plurality of multi-scale image features onto a BEV space representing an environment surrounding the vehicle; generating an adaptive BEV grid comprising a plurality of grid cells that incorporates a combination of the plurality of multi-scale image features; and adjusting a size of one or more of the plurality of grid cells based on one or more pre-defined factors.

Clause 2. The method of clause 1, further comprising: predicting, based on the adaptive BEV grid, a class label for one or more of the plurality of grid cells.

Clause 3. The method of clause 1, wherein adjusting the size of one or more of the plurality of grid cells further comprises: estimating a density of a plurality of object points detected around one or more of the plurality of grid cells in the adaptive BEV grid; and adjusting the size of a corresponding grid cell based on the density of the plurality of object points.

Clause 4. The method of clause 1, wherein generating the adaptive BEV grid and adjusting the size of one or more of the plurality of grid cells further comprises: generating a plurality of BEV grids for each of the one or more cameras of the first type and the one or more cameras of the second type; and adjusting the size of one or more of the plurality of BEV grids based on one or more parameters of a corresponding type; and generating the adaptive BEV grid by combining the plurality of BEV grids.

Clause 5. The method of clause 4, wherein adjusting the size of one or more of the plurality of BEV grids further comprises: determining a maximum BEV grid size based on the adjusted size of the one or more of the plurality of BEV grids; and adjusting the size of the one or more of the plurality of grid cells of the adaptive BEV grid based on the maximum BEV grid size.

Clause 6. The method of clause 4, further comprising: dividing the BEV space into a plurality of levels, wherein each level of the plurality of levels represents a different scale of detail of the environment surrounding the vehicle; and wherein the one or more parameters for adjusting the size of the one or more of the plurality of BEV grids define a range of possible grid sizes for a corresponding camera within a corresponding level of the plurality of levels.

Clause 7. The method of any of clauses 1-6, wherein one or more first areas of the adaptive BEV grid have higher resolution than one or more second areas of the adaptive BEV grid and wherein the one or more first areas are located closer to the vehicle than the one or more second areas.

Clause 8. The method of any of clauses 1-6, wherein the one or more cameras of the second type have a wider field of view as compared to the one or more cameras of the first type.

Clause 9. The method of any of clauses 1-6, further comprising operating an Advanced Driver Assistance Systems (ADAS) system based on the generated adaptive BEV grid.

Clause 10. A system for generating an adaptive Birds-Eye-View (BEV) grid, the system comprising: a memory for storing sensor data; and processing circuitry in communication with the memory, wherein the processing circuitry is configured to: obtain the sensor data generated by one or more sensors of a vehicle, wherein the sensor data includes one or more images captured by one or more cameras of a first type having a first detection range and one or more images captured by one or more cameras of a second type having a second detection range; extract, from the sensor data, a plurality of features to generate a plurality of multi-scale image features; project the plurality of multi-scale image features onto a BEV space representing an environment surrounding the vehicle; generate an adaptive BEV grid comprising a plurality of grid cells that incorporates a combination of the plurality of multi-scale image features; and adjust a size of one or more of the plurality of grid cells based on one or more pre-defined factors.

Clause 11. The system of clause 10, wherein the processing circuitry is further configured to: predict, based on the adaptive BEV grid, a class label for one or more of the plurality of grid cells.

Clause 12. The system of clause 10, wherein the processing circuitry configured to adjust the size of one or more of the plurality of grid cells is further configured to: estimate a density of a plurality of object points detected around one or more of the plurality of grid cells in the adaptive BEV grid; and adjust the size of a corresponding grid cell based on the density of the plurality of object points.

Clause 13. The system of clause 10, wherein the processing circuitry configured to generate the adaptive BEV grid and to adjust the size of one or more of the plurality of grid cells is further configured to: generate a plurality of BEV grids for each of the one or more cameras of the first type and the one or more cameras of the second type; and adjust the size of one or more of the plurality of BEV grids based on one or more parameters of a corresponding type; and generate the adaptive BEV grid by combining the plurality of BEV grids.

Clause 14. The system of clause 13, wherein the processing circuitry configured to adjust the size of one or more of the plurality of grid cells is further configured to: determine a maximum BEV grid size based on the adjusted size of the one or more of the plurality of BEV grids; and adjust the size of the one or more of the plurality of grid cells of the adaptive BEV grid based on the maximum BEV grid size.

Clause 15. The system of clause 13, wherein the processing circuitry is further configured to: divide the BEV space into a plurality of levels, wherein each level of the plurality of levels represents a different scale of detail of the environment surrounding the vehicle; and wherein the one or more parameters for adjusting the size of the one or more of the plurality of BEV grids define a range of possible grid sizes for a corresponding camera within a corresponding level of the plurality of levels.

Clause 16. The system of any of clauses 10-15, wherein one or more first areas of the adaptive BEV grid have higher resolution than one or more second areas of the adaptive BEV grid and wherein the one or more first areas are located closer to the vehicle than the one or more second areas.

Clause 17. The system of any of clauses 10-15, wherein the one or more cameras of the second type have a wider field of view as compared to the one or more cameras of the first type.

Clause 18. The system of any of clauses 10-15, wherein the processing circuitry is further configured to: operate an Advanced Driver Assistance Systems (ADAS) system based on the generated adaptive BEV grid.

Clause 19. Non-transitory computer-readable storage media having instructions encoded thereon, the instructions configured to cause processing circuitry to: obtain sensor data generated by one or more sensors of a vehicle, wherein the sensor data includes one or more images captured by one or more cameras of a first type having a first detection range and one or more images captured by one or more cameras of a second type having a second detection range; extract, from the sensor data, a plurality of features to generate a plurality of multi-scale image features; project the plurality of multi-scale image features onto a BEV space representing an environment surrounding the vehicle; generate an adaptive BEV grid comprising a plurality of grid cells that incorporates a combination of the plurality of multi-scale image features; and adjust a size of one or more of the plurality of grid cells is adjusted based on one or more pre-defined factors.

Clause 20. The non-transitory computer-readable storage media of clause 19, wherein the instructions are further configured to cause the processing circuitry to: predict, based on the adaptive BEV grid, a class label for one or more of the plurality of grid cells.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules or units configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for generating an adaptive Birds-Eye-View (BEV) grid comprising:
obtaining sensor data generated by one or more sensors of a vehicle, wherein the sensor data includes one or more images captured by one or more cameras of a first type having a first detection range and one or more images captured by one or more cameras of a second type having a second detection range;
extracting, from the sensor data, a plurality of features to generate a plurality of multi-scale image features;
projecting the plurality of multi-scale image features onto a BEV space representing an environment surrounding the vehicle;
generating an adaptive BEV grid comprising a plurality of grid cells that incorporates a combination of the plurality of multi-scale image features; and
adjusting a size of one or more of the plurality of grid cells based on one or more pre-defined factors.

2. The method of claim 1, further comprising:
predicting, based on the adaptive BEV grid, a class label for one or more of the plurality of grid cells.

3. The method of claim 1, wherein adjusting the size of one or more of the plurality of grid cells further comprises:
estimating a density of a plurality of object points detected around one or more of the plurality of grid cells in the adaptive BEV grid; and
adjusting the size of a corresponding grid cell based on the density of the plurality of object points.

4. The method of claim 1, wherein generating the adaptive BEV grid and adjusting the size of one or more of the plurality of grid cells further comprises:
generating a plurality of BEV grids for each of the one or more cameras of the first type and the one or more cameras of the second type; and
adjusting the size of one or more of the plurality of BEV grids based on one or more parameters of a corresponding type; and
generating the adaptive BEV grid by combining the plurality of BEV grids.

5. The method of claim 4, wherein adjusting the size of one or more of the plurality of BEV grids further comprises:
determining a maximum BEV grid size based on the adjusted size of the one or more of the plurality of BEV grids; and
adjusting the size of the one or more of the plurality of grid cells of the adaptive BEV grid based on the maximum BEV grid size.

6. The method of claim 4, further comprising:
dividing the BEV space into a plurality of levels, wherein each level of the plurality of levels represents a different scale of detail of the environment surrounding the vehicle; and
wherein the one or more parameters for adjusting the size of the one or more of the plurality of BEV grids define a range of possible grid sizes for a corresponding camera within a corresponding level of the plurality of levels.

7. The method of claim 1, wherein one or more first areas of the adaptive BEV grid have higher resolution than one or more second areas of the adaptive BEV grid and wherein the one or more first areas are located closer to the vehicle than the one or more second areas.

8. The method of claim 1, wherein the one or more cameras of the second type have a wider field of view as compared to the one or more cameras of the first type.

9. The method of claim 1, further comprising operating an Advanced Driver Assistance Systems (ADAS) system based on the generated adaptive BEV grid.

10. A system for generating an adaptive Birds-Eye-View (BEV) grid, the system comprising:
a memory for storing sensor data; and
processing circuitry in communication with the memory, wherein the processing circuitry is configured to:
obtain the sensor data generated by one or more sensors of a vehicle, wherein the sensor data includes one or more images captured by one or more cameras of a first type having a first detection range and one or more images captured by one or more cameras of a second type having a second detection range;
extract, from the sensor data, a plurality of features to generate a plurality of multi-scale image features;
project the plurality of multi-scale image features onto a BEV space representing an environment surrounding the vehicle;
generate an adaptive BEV grid comprising a plurality of grid cells that incorporates a combination of the plurality of multi-scale image features; and
adjust a size of one or more of the plurality of grid cells based on one or more pre-defined factors.

11. The system of claim 10, wherein the processing circuitry is further configured to:
predict, based on the adaptive BEV grid, a class label for one or more of the plurality of grid cells.

12. The system of claim 10, wherein the processing circuitry configured to adjust the size of one or more of the plurality of grid cells is further configured to:
estimate a density of a plurality of object points detected around one or more of the plurality of grid cells in the adaptive BEV grid; and
adjust the size of a corresponding grid cell based on the density of the plurality of object points.

13. The system of claim 10, wherein the processing circuitry configured to generate the adaptive BEV grid and to adjust the size of one or more of the plurality of grid cells is further configured to:
generate a plurality of BEV grids for each of the one or more cameras of the first type and the one or more cameras of the second type; and
adjust the size of one or more of the plurality of BEV grids based on one or more parameters of a corresponding type; and
generate the adaptive BEV grid by combining the plurality of BEV grids.

14. The system of claim 13, wherein the processing circuitry configured to adjust the size of one or more of the plurality of grid cells is further configured to:
determine a maximum BEV grid size based on the adjusted size of the one or more of the plurality of BEV grids; and
adjust the size of the one or more of the plurality of grid cells of the adaptive BEV grid based on the maximum BEV grid size.

15. The system of claim 13, wherein the processing circuitry is further configured to:
divide the BEV space into a plurality of levels, wherein each level of the plurality of levels represents a different scale of detail of the environment surrounding the vehicle; and
wherein the one or more parameters for adjusting the size of the one or more of the plurality of BEV grids define a range of possible grid sizes for a corresponding camera within a corresponding level of the plurality of levels.

16. The system of claim 10, wherein one or more first areas of the adaptive BEV grid have higher resolution than one or more second areas of the adaptive BEV grid and wherein the one or more first areas are located closer to the vehicle than the one or more second areas.

17. The system of claim 10, wherein the one or more cameras of the second type have a wider field of view as compared to the one or more cameras of the first type.

18. The system of claim 10, wherein the processing circuitry is further configured to:
operate an Advanced Driver Assistance Systems (ADAS) system based on the generated adaptive BEV grid.

19. Non-transitory computer-readable storage media having instructions encoded thereon, the instructions configured to cause processing circuitry to:
obtain sensor data generated by one or more sensors of a vehicle, wherein the sensor data includes one or more images captured by one or more cameras of a first type having a first detection range and one or more images captured by one or more cameras of a second type having a second detection range;
extract, from the sensor data, a plurality of features to generate a plurality of multi-scale image features;
project the plurality of multi-scale image features onto a BEV space representing an environment surrounding the vehicle;
generate an adaptive BEV grid comprising a plurality of grid cells that incorporates a combination of the plurality of multi-scale image features; and
adjust a size of one or more of the plurality of grid cells based on one or more pre-defined factors.

20. The non-transitory computer-readable storage media of claim 19, wherein the instructions are further configured to cause the processing circuitry to:
predict, based on the adaptive BEV grid, a class label for one or more of the plurality of grid cells.
